(19) United States
(12) Patent Application Publication
(10) Pub. No.: US 2023/0244639 A1
(43) Pub. Date: Aug. 3, 2023

(54) A SYSTEM FOR MODIFYING AN ARRANGEMENT OF FILES

(71) Applicant: CSER VENTURES, LLC, Melbourne, FL (US)

(72) Inventors: Carmine John Silano, Melbourne, FL (US); Edward Roberts, Melbourne, FL (US); R. Maxwell Flaherty, Topsfield, MA (US); J. Christopher Flaherty, Nottingham, NH (US)

(21) Appl. No.: 17/928,717

(22) PCT Filed: Jun. 3, 2021
(86) PCT No.: PCT/US2021/035624

§ 371 Date: Nov. 30, 2022

Related U.S. Application Data
(60) Provisional application No. 63/034,136, filed on Jun. 3, 2020.

(51) Int. Cl. G06F 16/16; G06F 3/0484

(52) U.S. Cl. CPC G06F 16/168; G06F 3/0484; G06F 3/165

(57) ABSTRACT

A system for editing an arrangement comprising information regarding the relationship between two or more source data files comprises a processing unit, a first library comprising one or more source data files, and a user interface. The user interface comprises a display and a user input. The processing unit provides a graphical user interface on the display. The processing unit is configured such that a user can modify an initial arrangement of source data files via the graphical user interface to produce a modified arrangement of source data files.

### RELATED APPLICATIONS

The present application claims priority to U.S. Provisional Application Serial Number 63/034,136, entitled “A System for Modifying an Arrangement of Files”, filed Jun. 3, 2020, the content of which is incorporated herein by reference in its entirety.

The present application, while not claiming priority to, may be related to U.S. Pat. Application Serial No. 17/284,990, entitled “System for Generating an Output File”, filed Apr. 13, 2021, United States Publication Number______, published ______, which is a 35 USC 371 national stage filing of Patent Cooperation Treaty Application Serial Number PCT/US2019/059352, entitled “System for Generating an Output File”, filed Nov. 1, 2019, Publication Number WO2020/092879, published May 7, 2020, which claims priority to U.S. Provisional Pat. Application Serial No. 62/754,881, entitled “System for Generating an Output File”, filed Nov. 2, 2018, and U.S. Provisional Pat. Application Serial No. 62/871,514, entitled “System for Generating an Output File”, filed Jul. 8, 2019, the content of each of which is incorporated herein by reference in its entirety.

The present application, while not claiming priority to, may be related to U.S. Pat. Application Serial No. 16/702,907, entitled “System for Generating an Output File”, filed Dec. 4, 2019, U.S. Publication Number 2020-0349973, published Nov. 5, 2020, which is a continuation of United States Patent Application Serial Number 15/520,972, entitled “System for Generating an Output File”, filed Apr. 21, 2017, United States Patent Number 10,535,370, issued Jan. 14, 2020, which is a 35 USC 371 national stage filing of Patent Cooperation Treaty Application Serial Number PCT/US2015/056398, entitled “System for Generating an Output File”, filed Oct. 20, 2015, Publication Number WO2016/064830, published Apr. 28, 2016, which claims priority to U.S. Provisional Pat. Application Serial No. 62/066,932, entitled “System for Generating an Output File”, filed Oct. 22, 2014, the content of each of which is incorporated herein by reference in its entirety.

### FIELD

The present inventive concepts generally relate to the field of systems for modifying sets of files, and in particular electronic files that include audio and/or video files.

### BACKGROUND

In the cheerleading and dance industry, there are two main types of musical accompaniment available for teams in these industries to purchase. The first, custom music, requires a significant effort from both the customer and the music provider. Such custom music is generally only sold to a single team, and it is often used by that team for only a single season. This custom option can be cost prohibitive to a majority of teams. The second type, premade music, requires similar input from the provider, but generally sells for a significantly lower price than custom music. These premade mixes generally follow a common structure and are produced at the sole discretion of the provider, which can lower the overall cost to produce. Additionally, premade mixes are sometimes sold to multiple teams, lowering their perceived value. There is a need in these industries for teams to be able to purchase premade music, and to customize that music to their team and routine without increasing the cost prohibitively. Systems and methods meeting this need are described herein.

### SUMMARY

According to an aspect of the present inventive concepts, a system for a user to edit an arrangement comprising information regarding the relationship between two or more source data files comprises a processing unit, a first library comprising one or more source data files, and a user interface comprising a display and a user input device. The processing unit can provide a graphical user interface on the display. The processing unit can be configured such that the user can modify an initial arrangement of source data files via the graphical user interface to produce a modified arrangement of source data files.

In some embodiments, the system further comprises a second library comprising one or more arrangements of source data files. The initial arrangement can be selected by the user from the second library.

In some embodiments, the system is configured to produce an output file based on the modified arrangement.

In some embodiments, the system further comprises a streaming player configured to stream an output file to one or more users of the system. The streaming player can be configured to provide streaming of at least a portion of the output file prior to purchase of the output file. The streaming player can provide streaming of the output file at a limited bitrate and/or at another limited quality.

In some embodiments, the source data files comprise proprietary media. The system can be configured to track and manage the use, distribution, and/or sale of the proprietary media. The system can be configured to provide a license to the user for the use of the proprietary media. The system can be configured to update the license information based on a geographic location of the user and/or intended geographic usage locations of the proprietary media.

In some embodiments, the processing unit is configured to store user data. User data can comprise information pertaining to user owned licenses to one or more source data files.

In some embodiments, the system comprises an algorithm configured to identify patterns and/or behaviors unique to the user. The algorithm can generate a behavior profile for the user.

In some embodiments, the system is configured to allow a first user to provide rights and/or access to one or more source data files to a second user. The system can be configured to facilitate compensation of the first user by the second user for the rights and/or access to the source data file.

In some embodiments, the system comprises an algorithm configured to analyze information to be included in an output file, and the algorithm determines if a subset of information should be removed. The algorithm can analyze audio and/or visual information within the output file, and the algorithm can remove explicit language and/or explicit images. The algorithm can swap source data files comprising explicit language and/or explicit images with similar source data files that do not comprise explicit language and/or explicit images.

In some embodiments, the system comprises an algorithm configured to automatically generate the initial arrangement comprising two or more source data files. The algorithm can be configured to generate the initial arrangement based on a set of rules. The set of rules can be defined by a manufacturer. The set of rules can be defined by preferences of the user. The algorithm can comprise a fall back set of rules configured to be implemented if no source data files satisfy the criteria based on a current set of rules. The algorithm can comprise a bias, and the initial arrangement can be generated based on the bias. The bias can be based on user input. The bias can comprise a bias toward and/or away from a particular type of source data file. The bias can comprise a bias toward producing an arrangement comprising a mix of source data files. The mix of source data files can comprise a set of files comprising dissimilar types, forms, and/or representations of the content of the files.

In some embodiments, the system is configured to display that arrangement source data files in a grid format. The grid format can comprise multiple cells, and each cell can represent a duration of time.

In some embodiments, the system comprises an algorithm configured to determine a purchase cost of the arrangement based on a user parameter selected from the group consisting of: the type of level of a user’s subscription; a user’s geographic location; the number of times a user has purchased an output file; and combinations thereof.

In some embodiments, the graphical user interface is configured to allow the user to select one or more source data files to be replaced within the arrangement. The system can further comprise an algorithm configured to analyze the replaced source data files and to provide the user with qualitative and/or quantitative information related to the replacement. The system can further comprise an algorithm configured to compare the length of the original source data files to those of the replacement source data files. The algorithm can alert the user if the lengths of the original and replacement files differ beyond a threshold. The system can further comprise an algorithm configured to automatically replace one or more of the source data files based on the availability of a license to the files.

In some embodiments, the graphical user interface comprises a control configured to initiate an automatic generation of the arrangement with a single user action.

In some embodiments, the graphical user interface is configured to allow the user to reorder one or more source data files within the arrangement. The algorithm can determine the placement of the reordered source data files. The algorithm can determine the placement based on a set of rules. The set of rules can be based on the direction of movement of the source data files. The set of rules can be based on a threshold of the amount of a first icon overlaps a second icon. The threshold can comprise at least 1%, at least 25%, or at least 50% overlap of the icons.

In some embodiments, the system comprises an algorithm configured to adjust the duration of the arrangement by applying a time-stretch function to at least a portion of the arrangement. The algorithm can maintain a timing alignment between overlapping source data files while performing the time-stretch function. The arrangement can comprise overlapping audio and video source data files, and the algorithm can maintain synchronization between the audio and video files while a time-stretch function is performed on both files. The arrangement can comprise two or more source data files that are overlapped, and a time-stretch function can be performed on a single source data file, and synchronization between the source data files can become out of sync. The algorithm can maintain the length of the arrangement by adjusting one or more properties of the source data files as the user adds or removes the one or more of the source data files.

In some embodiments, the system comprises an algorithm configured to calculate the cost for the user to license an output file. The algorithm can determine the costs associated with each source data file included in the arrangement and the costs of any user modifications made to the arrangement.

In some embodiments, the system is configured to provide a license to perform an act based on an output file and/or to perform an act in a synchronized manner with an output file.

According to another aspect of the present inventive concepts, a method for searching a library of source data based on user input comprising producing a search file based on the user input, analyzing the search file to identify one or more characteristics of the input, and identifying one or more source data files based on the identified characteristics.

### INCORPORATION BY REFERENCE

All publications, patents, and patent applications mentioned in this specification are herein incorporated by reference to the same extent as if each individual publication, patent, or patent application was specifically and individually indicated to be incorporated by reference. The content of all publications, patents, and patent applications mentioned in this specification are herein incorporated by reference in their entirety for all purposes.

### BRIEF DESCRIPTION OF THE DRAWINGS

The foregoing and other features and advantages of the inventive concepts will be apparent from the more particular description of embodiments of the inventive concepts, as illustrated in the accompanying drawings in which like reference characters refer to the same parts throughout the different views. The drawings are not necessarily to scale, emphasis instead being placed upon illustrating the principles of the inventive concepts.

FIG. 1 illustrates a schematic view of a file editing system including a graphical user interface, consistent with the present inventive concepts.

FIGS. 2-18 illustrate various embodiments of a graphical user interface of a file editing system, consistent with the present inventive concepts.

FIG. 19 illustrates a method of searching a library of source data based on a user input, consistent with the present inventive concepts.

### DETAILED DESCRIPTION

Various example embodiments will be described more fully hereinafter with reference to the accompanying drawings, in which some example embodiments are shown. The present inventive concepts may, however, be embodied in many different forms and should not be construed as limited to the example embodiments set forth herein.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of two or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer, or section. Thus, a first element, component, region, layer or section discussed below could be termed a second element, component, region, layer or section without departing from the teachings of the present inventive concepts.

Spatially relative terms, such as “beneath,” “below,” “lower,” “above,” “upper” and the like, may be used herein for ease of description to describe one element’s or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concepts. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one, two, or more other features, integers, steps, operations, elements, components, and/or groups thereof.

The terms “and combinations thereof” and “and combinations of these” can each be used herein after a list of items that are to be included singly or collectively. For example, a component, process, and/or other item selected from the group consisting of: A; B; C; and combinations thereof, shall include a set of one or more components that comprise: one, two, three or more of item A; one, two, three or more of item B; and/or one, two, three, or more of item C.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the present inventive concepts.

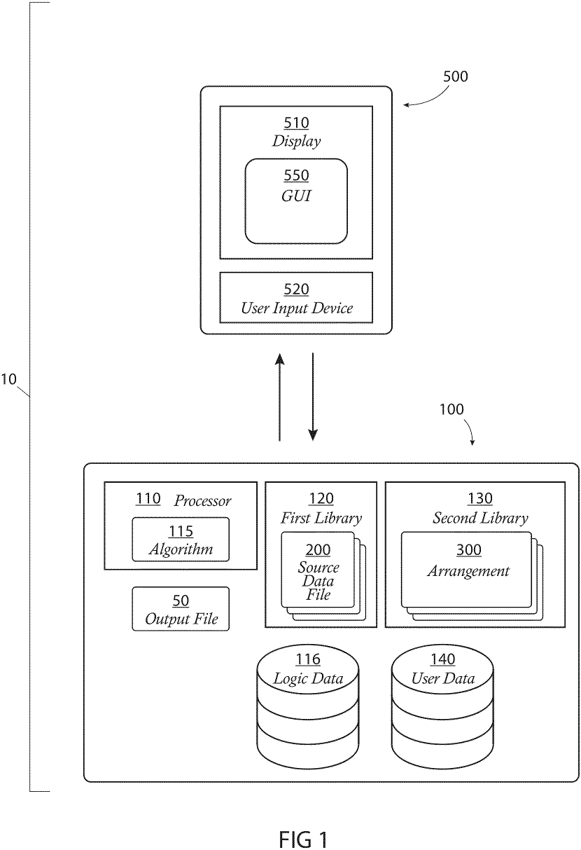

Referring now to FIG. 1, a schematic view of a file editing system including a graphical user interface is illustrated, consistent with the present inventive concepts. System 10 can comprise one or more systems for creating and/or editing (“editing” herein) one or more electronic files and/or other files (“files” herein). System 10 can be provided to one or more users and/or groups of users (“user” herein) by a manufacturer, distributor, and/or other host (“host” herein) of system 10. System 10 includes a processing unit 100 and a user interface 500, both shown. User interface 500 can comprise a video monitor and/or other display device, display 510, as well as a user input device 520, both shown. User input device 520 can include one or more user input devices, such as are described herein. Processing unit 100 can provide a graphical user interface, GUI 550 shown, to be displayed on display 510 of user interface 500. System 10, via GUI 550, can be configured to enable a user to modify an arrangement of one, two, or more files, initial arrangement 300_{I} shown, thereby producing a modified arrangement comprising one, two, or more files, modified arrangement 300_{M} shown. System 10 can be configured to produce an output file, output file 50 shown, based on an arrangement of files, such as is described herein.

Processing unit 100 can comprise at least one microprocessor, computer, and/or other electronic controller, processor 110 shown. Processing unit 100 can also include one or more algorithms, algorithm 115 shown. Algorithm 115 can comprise a machine learning, neural net, and/or other artificial intelligence algorithm (“AI algorithm” herein). Processor 110, such as via algorithm 115, can perform and/or otherwise support the performance of one or more of the processes described herein, such as a process that is performed in response to one or more commands that a user inputs into system 10 via GUI 550. In some embodiments, algorithm 115 is configured to perform one or more actions based on logic data stored by system 10, logic data 116 shown. Logic data 116 can comprise one or more rules, instructions, thresholds, and/or process parameters.

System 10 can store, generate, and/or otherwise provide one or more files, source data files 200 shown, that can be included in arrangement 300_{I} and/or 300_{M} (singly or collectively arrangement 300). Processing unit 100 can comprise a first data repository, first library 120 shown, where the multiple source data files 200 are stored by processing unit 100 (e.g. stored in memory of processing unit 100). First library 120 can comprise one or more source data files 200 shown, where files 200 comprise files of a file type selected from the group consisting of: audio files; music files; sound effect files; voice-over files; text files; image files; video files; a file comprising movements and/or placement instructions, such as a file comprising choreography instruction; and combinations of these. In some embodiments, a first source data file 200 comprises a source data modifier file 200_{M} that includes a set of instructions for modifying one or more second source data files 200, for example, a portion of a second source data file 200 that overlaps (e.g. visually overlaps) the source data modifier file 200_{M} in arrangement 300. For example, a source data modifier file 200_{M} can comprise a “record stop” modifier comprising a set of instructions (e.g. one or more instructions to be executed by processor 110 in producing output file 50) for simulating the effect of a record player being stopped (e.g. simulating the effect using an overlapping portion of a source data file 200). In some embodiments, source data modifier file 200_{M} includes one or more adjustments provided by an audio equalizer, such as a “bass boost”. An arrangement 300 can comprise information regarding the relationship between two or more source data files 200, as well as metadata regarding the inclusion of each source data file 200 in an associated output file 50. For example, metadata relating to a source data file 200 can including: duration; tempo; playback rate, such as a positive or a negative (forward or backward) playback rate, and/or a mapped playback rate; relative volume; start and/or end position; pitch; movement; and combinations of these. In some embodiments, processing unit 100 comprises a second data repository, second library 130 shown, where one or more arrangements 300 (e.g. one or more initial arrangements 300_{I}) are stored by system processing unit 100 (e.g. stored in memory of processing unit 100).

System 10 can be configured to produce output file 50. Output file 50 can comprise one or more files that are based on an arrangement 300 (e.g. a modified arrangement 300_{M}) of multiple source data files 200. In some embodiments, system 10 produces output file 50 by performing a function such as: rendering the output file 50, mastering the output file 50, and/or otherwise digitally generating the output file 50. In some embodiments, output file 50 is produced in a manner similar to that described in applicant’s co-pending U.S. Pat. Application Serial No. 16/702,907, titled “System for Generating an Output File”, filed Dec. 4, 2019, and/or applicant’s co-pending U.S. Pat. Application Serial No. 17/284,990, titled “System for Generating an Output File”, filed Apr. 13, 2021. In some embodiments, system 10 provides output file 50 to the user such that output file 50 can be purchased by the user (e.g. needs to be purchased for the user to have access to output file 50). In some embodiments, system 10 is configured to stream output file 50 to one or more users (e.g. when system 10 comprises a streaming music player). In some embodiments, system 10 is configured to provide streaming of at least a portion of output file 50 prior to purchase of output file 50 by the user, for example, streaming that is provided at a limited bitrate, with limited fidelity, with a audible overlay (e.g. a “watermark”) and/or otherwise with limited quality (e.g. relative to a purchased version of output file 50).

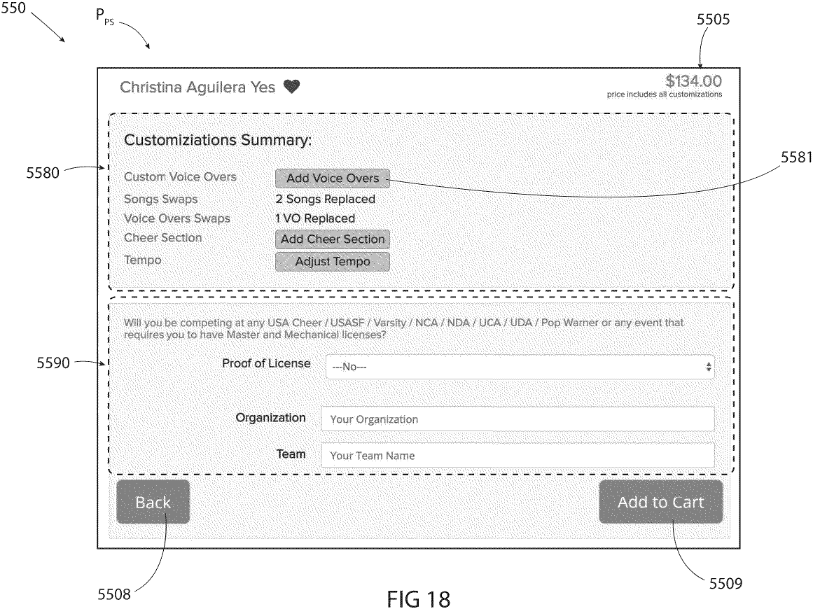

In some embodiments, the various source data files 200 and/or output files 50 of system 10 comprise “proprietary media” (e.g. copyrighted songs and/or recordings). In some embodiments, the rights to these files are: owned by the manufacturer of system 10; licensed by the manufacturer of system 10; and/or owned by a third party. System 10 can be configured to track and manage the use, distribution, and/or sale of proprietary media through system 10. In some embodiments, system 10 is configured to provide one or more licenses to the user, for example, master and/or mechanical licenses for the use of output file 50, as described in reference to FIG. 18 and otherwise herein. In some embodiments, system 10 is configured to alert the user to the status of a license of a source data file 200 associated with an arrangement 300 (e.g. to alert the user if they do not have and/or would need to purchase a license to use the source data file 200). In some embodiments, system 10 updates license information based on the geographic location of the user and/or the intended geographic usage location of output file 50. For example, certain source data files 200 may be licensed for use in the United States and not in the United Kingdom (UK), and system 10 can be configured to warn users in the UK if a source data file is not licensed and/or licensable based on the user’s geographic location. In some embodiments, algorithm 115 is configured to automatically identify the user’s location and/or to confirm a user’s location (e.g. to prevent or at least attempt to foil malicious attempts to subvert licensing rules), such as via the user’s IP address.

Processing unit 100 can comprise a computer or other computing device (“computer” herein) that is positioned local to the user (e.g. in a location readily available to the user), and system 10 can comprise a stand-alone system, such as when system 10 comprises a program and data stored in memory (e.g. software) installed on and/or otherwise residing within the local computer. In alternative embodiments, processing unit 100 comprises multiple computers, such as multiple computers connected over a network, such as a network selected from the group consisting of: the Internet; a LAN; a cellular network; and combinations of these. In these embodiments, processing unit 100 can comprise one, two, or more computers selected from the group consisting of: desktop; laptop; server; storage device; tablet; phone; and combinations of these. In some embodiments, system 10 is configured to provide an Internet-based user interface, such as a user interface where display 510 is positioned local to the user and the images and other information shown on display 510 is generated via a web interface. In these embodiments, user interface 500 can comprise one, two, or more user input devices positioned local to the user and commands from user input device 520 can be received by the web interface. In some embodiments, the web interface of system 10 does not require an Internet or other network connection (e.g. when system 10 comprises a stand-alone system as described hereabove). In some embodiments, at least one computer of processing unit 100 is configured to support multiple users (e.g. simultaneously and/or sequentially). The multiple users can be at a location remote from the at least one computer, such as when the at least one computer of processing unit 100 comprises a server hosting multiple users via a web-based user interface. The at least one computer configured to host multiple users can be configured to perform multi-threaded processing and/or it can comprise multiple processors 110. In some embodiments, processing unit 100 is configured to be operated by one, two, or more users, such as when individual or group operator (i.e. user) access is managed by a login function of system 10, the login function comprising a security routine used to set (e.g. enter and/or modify) and/or confirm user passwords and/or user permissions. For example, multiple users can have unique login information, stored by one, two, or more memory portions of processing unit 100. Individual or groups of users can have different permission levels, such as administrator and/or standard user level permissions. In some embodiments, processing unit 100 stores this information as user data 140 shown. User data 140 can comprise user information selected from the group consisting of: user contact information, such as name, email, or phone number; user preference information; payment information; shopping cart information, for example, which items are in the user’s shopping cart (e.g. a shopping cart provided by system 10); user permission information; user purchase history information; license information, such as information pertaining to user owned licenses to one or more files of system 10; and combinations of these. In some embodiments, system 10 (e.g. via algorithm 115) is configured to identify patterns and/or behaviors unique the user (e.g. unique to each user of system 10). System 10 can generate a behavior profile for each user (e.g. a user behavioral “fingerprint”), such as a profile to be referenced by algorithm 115 to make tailored suggestions (e.g. suggestions of source data files 200 to be added to an arrangement 300 tailored to the behavior of the user) and/or to be referenced in data mining performed by system 10.

In some embodiments, user data 140 comprises links to one, two, or more arrangements 300, such as to associate the one, two, or more arrangements 300 to the particular user that created and/or modified the arrangements 300. In some embodiments, one, two, or more source data files 200 are associated with a user account, and the user of that account can share those source data files 200 with other users. Additionally or alternatively, one, two, or more configurations of preferred settings and/or other parameters can be saved to a user account and/or shared by a user, such as mix settings, voice-over settings, and/or parameters specific to an effect provided by system 10 (e.g. an audio effect). In some embodiments, one, two, or more source data files 200 are unique to a single user account (e.g. an account accessible only to that particular user). In some embodiments, the permission level of a user determines which source data files 200 are available to that user and/or other users. In some embodiments, system 10 is configured to allow a first user to provide rights (e.g. licensing rights) and/or access to one or more files (e.g. source data files 200, arrangements 300, and/or output files 50) to a second user. In some embodiments, system 10 is configured to facilitate compensation of the first user by the second user (e.g. allows the first user to sell one or more files to a second user).

In some embodiments, system 10 produces an output file 50 that is based on source data files 200 comprising at least one, two, or more image and/or video files, and at least one, two, or more audio files. In these embodiments, the image and/or video files can comprise medical image files, such as: images of histology slides and/or other slides representing health information of a patient; and/or medical images and/or videos of a patient, such as images and/or videos produced by a fluoroscope, an X-ray, an MRI, a CT-scanner, a PET scanner, OCT imaging device, and/or ultrasound imaging device. The associated audio files of files 200 that are used to create output file 50 can comprise a narration, analysis, and/or other spoken word description of the medical image and/or video files that are included. Alternatively or additionally, source data files 200 can comprise image and/or video files representing an event such as a sporting event, a political event, and/or other newsworthy event. Here the associated audio files of files 200 that use used to produce output file 50 can comprise a narration, analysis, and/or other spoken word description of the images and/or video files of the newsworthy event.

In some embodiments, algorithm 115 is configured to analyze information, such as information to potentially be included in an output file 50, and to determine if any particular subset of information should be removed. For example, system 10 can be configured to produce an output file 50 comprising medical information related to a patient. In these embodiments, algorithm 115 can be configured to remove particular information (e.g. audio, text, and/or other information), such as information that would otherwise reveal the particular identity of the patient. As another example, algorithm 115 can be configured to analyze audio and/or visual information contained within output file 50 and to remove any explicit content, such as explicit language and/or images. In some embodiments, algorithm 115 can be configured to swap a source data file 200 (as described herein) within an arrangement 300 based on a desired rating (e.g. a parental guidance rating) of the associated output file 50. For example, algorithm 115 can be configured to swap source data files 200 comprising explicit language with similar source data files 200 without explicit language.

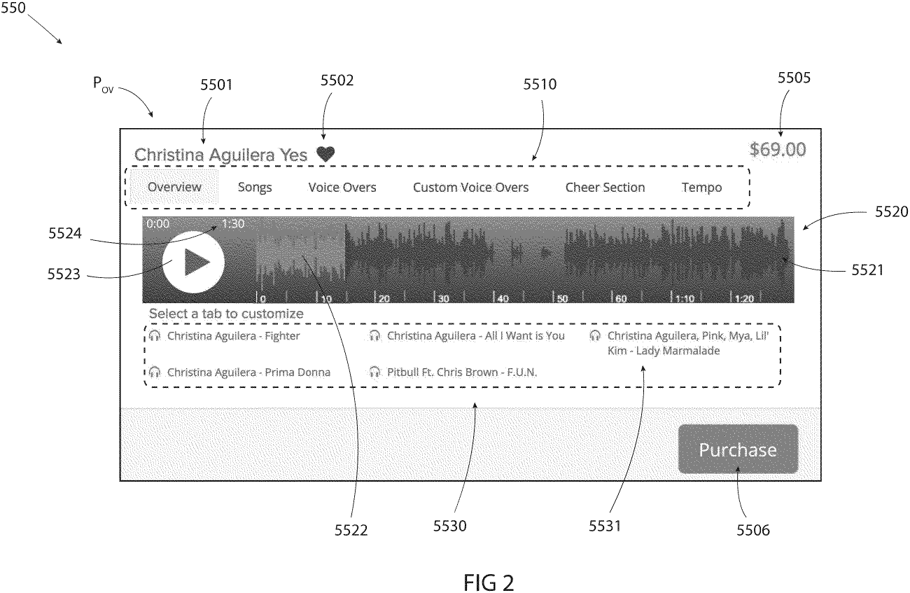

In the embodiments described herebelow in reference to FIGS. 2 - 18, arrangements 300 comprise arrangements of source data files 200 comprising audio files. Output file 50 provided by system 10 comprises an audio file (e.g. one, two, or more audio files) produced by mastering the audio-based source data files 200 to produce a song or mix of songs, including one, two, or more sound effects, transitions, voice-overs, and/or other auditory elements. Included in the scope of the present inventive concepts, source data files 200, arrangements 300, and/or output files 50 can comprise files with a file type selected from the group consisting of: audio files; video files; combined audio and video files; text files; image files; combined audio and image files; combined audio, image, and video files; files including tabular data; files including musical notation sequences; files including file modification instructions; files comprising movements and/or placement instructions, such as a file comprising choreography instruction; and combinations of these. In some embodiments, system 10 is configured to produce an output file 50 comprising choreography instruction (e.g. a text or other data file), wherein the various source data files 200 associated with output file 50 comprise various movement, placement, and/or skill information, arranged based on timing of the choreographed event (e.g. an event to be synchronized to music). The examples as described in reference to FIGS. 2-18 illustrate embodiments of system 10 configured to produce an output file 50 comprising a musical score, such as a score used as accompaniment to a choreographed routine, such as a dance or cheerleading routine. It should be understood that similar configurations of system 10 can be used to produce output files representing other subject matter, such as a medical-based output file 50 and/or news-based output file 50, such as are described hereabove.

GUI 550 can comprise one or more user selectable and/or activatable portions, “controls” herein. As used herein, “comprising a control” (e.g. GUI 550 comprises control X) and/or “a control is displayed on” (e.g. control X is displayed on GUI 550), and the like, can be used interchangeably to indicate that a control is displayed to the user via GUI 550, such that the user can interact with the control (e.g. via user input device 520) to perform an action as described herein. Furthermore, being displayed to the user “via GUI 550” can indicate the rendering of a graphic (e.g. a graphic control of GUI 550) on display 510 of user interface 500. The one or more controls of GUI 550 can be configured to initiate at least one action of system 10 (e.g. when selected by the user), such as to change the information displayed on GUI 550; perform an action related to the modification of arrangement 300; start and/or stop playback of a file; initiate the purchase of an output file 50; apply a filter (e.g. a data and/or other filter, such as a filter determined by algorithm 115 or otherwise); and/or perform one or more other actions as described herein. In some embodiments, a control of GUI 550 includes an icon representing a source data file 200. GUI 550 can be configured such that one or more controls (e.g. one or more icons) are enabled with a “drag and drop” function, such that the user can “drag” (e.g. move) the control to a new position on GUI 550 (and “dropped” there) to initiate an action of system 10 (e.g. to drag an icon representing a source data file 200 to thereby change the position of the file in arrangement 300). In some embodiments, an icon of GUI 550 comprises displayed text configured as a hyperlink. GUI 550 can comprise one or more pages, menus, pop-up displays, and/or other portions in which a set of data and/or controls can be displayed. GUI 550 can comprise one or more controls configured to allow the user to navigate between these various data sets, as described herein. In some embodiments, system 10 is configured to allow a user to create one or more controls, such as a control configured to initiate the performance of a series of events (a “macro”) that are defined by the user.

In some embodiments, algorithm 115 of system 10 is configured to automatically (e.g. without or with limited user interaction), generate an arrangement 300 of two or more source data files 200. Algorithm 115 can be configured similar to similar algorithms described in applicant’s co-pending U.S. Pat. Application Serial No. 17/284,990, titled “System for Generating an Output File”, filed Apr. 13, 2021. In some embodiments, algorithm 115 can produce an output file 50 based on the automatically generated arrangement 300. Output file 50 can comprise a file type selected from the group consisting of: a text file; a script file, such as a JSON string; a file containing one or more database entries; an XML-like file type; other output file types described herein; and combinations of these.

In some embodiments, one or more user determined arrangement guidelines are input into system 10 (e.g. via user interface 500). These guidelines can indicate the user’s desires, goals, and/or other preferences for how system 10 automatically generates an arrangement 300. Algorithm 115 can be configured to analyze these preferences and generate an arrangement 300 of source data files 200 based at least in part on these preferences. Algorithm 115 can generate arrangement 300 based on a set of rules, for example pre-programed rules defined by the manufacturer of system 10, and/or rules based on the user preferences. In some embodiments, the set of rules comprises rules that dictate the order and type of sections of an arrangement 300, for example an intro section that must be at the beginning of the arrangement. In some embodiments, algorithm 115 processes the set of rules in an order, for example, an order in which a first rule is followed (e.g. a first source data file is selected based on a first rule), after which a second rule is followed, (e.g. a second source data file is selected based on the second rule and any source data file previously selected based on previous rules). In some embodiments, rules dictate what percentages of automatically generated arrangements 300 comprise which types of source data files 200 (e.g. 50% music and 50% voiceovers). In some embodiments, one or more rules used by algorithm 115 can comprise a a weighting factor (e.g. a metric related to how strictly algorithm 115 must follow the rule). In some embodiments, algorithm 115 comprises a “fall back” set of rules, in other words a set of rules to follow if no source data files 200 satisfy the criteria based on a current set of rules. In some embodiments, if algorithm 115 cannot successfully generate an arrangement 300 based on a first set of rules, system 10 is configured to alert the user before using the fall back rules. In some embodiments, GUI 550 comprises a control configured to initiate the automatic generation of an arrangement 300 with a single user action (e.g. a single user input, such as a single “click”). In some embodiments, algorithm 115 can analyze all arrangements 300 of library 130 to ensure an automatically generated arrangement 300 is unique (e.g. does not currently exist in library 130).

In some embodiments, algorithm 115 comprises a bias when automatically generating an arrangement 300. In some embodiments, the bias can be based on user input. For example, algorithm 115 can be biased toward and/or away from a particular type of source data file 200, such as an audio file comprising music of a particular genre. In some embodiments, algorithm 115 is biased toward producing an arrangement with a mix of types of source data files 200, such as files comprising a mix of genres instead of a single genre. In some embodiments, the mix of types of source data files 200 includes files of different types, forms, and/or representations of the content of the files. Algorithm 115 can comprise a bias based on cost of the source data files 200, such as a bias toward more or less expensive source data files 200. In some embodiments, algorithm 115 comprises a bias based on the content of source data files 200, such as genre, particular languages or accents of speakers or singers, subject matter, and the like.

In some embodiments, system 10 is configured to display the various source data files 200 of arrangement 300 in a grid format. The grid can comprise multiple cells, where each cell can represent a duration of time, and each associated source data file 200 can be displayed relative to the grid. A grid format of system 10 can be similar to grid images described in applicant’s co-pending U.S. Pat. Application Serial No. 16/702,907, titled “System for Generating an Output File”, filed Dec. 4, 2019. In some embodiments, system 10 is configured to switch between a timeline-based display of arrangement 300 (e.g. waveform display 5521 described herein) and a grid-based display. In some embodiments, system 10 is configured to switch the display format based on user input (e.g. the user can choose to switch the display format). Additionally or alternatively, system 10 can be configured to select a display format based on actions to be performed (e.g. algorithm 115 can automatically select a format that best suits the activity of the user, such as based on previous activity performed by the user).

Referring now to FIGS. 2 - 18, various embodiments of a graphical user interface of a file editing system are illustrated, consistent with the present inventive concepts. As illustrated, GUI 550 can comprise a navigation control, tab control 5510. Tab control 5510 can include one or more icons linking to various pages of GUI 550, such as icons linking to the following pages (as shown): Overview Songs, Voice Overs, Custom Voice Overs, Cheer Section, and Tempo.

GUI 550 can comprise an information display, title display 5501, indicating the name of an arrangement 300 (e.g. the name of an initial arrangement 300_{I}). Additionally, GUI 550 can comprise favorite control 5502. Favorite control 5502 can comprise a control that is configured to flag arrangement 300 as a user “favorite” (e.g. to indicate arrangement 300 as a favorite in user data 140). GUI 550 can comprise cost display 5505. Cost display 5505 can comprise an information display that indicates the cost to purchase an output file 50 associated with arrangement 300 (“purchase cost” herein). In some embodiments, as the user modifies arrangement 300 via GUI 550, system 10 (e.g. via algorithm 115) is configured to recalculate the purchase cost (e.g. the amount indicated by cost display 5505 described herein) based on the modifications made. In some embodiments, if a modification is made which affects the purchase cost, system 10 is configured to alert the user to the change, such as via a pop-up notification displayed on GUI 550 and/or an audible alert produced by system 10. GUI 550 can comprise a control configured to initiate the purchase of output file 50, purchase button 5506. In some embodiments, purchase button 5506 initiates the production of output file 50 by system 10. Additionally, purchase button 5506 can navigate GUI 550 to a “Purchase Overview” page, such as is described herein in reference to FIG. 18.

In some embodiments, algorithm 115 is configured to determine the purchase cost of an arrangement 300. For example, algorithm 115 can determine the purchase cost based at least in part on a characteristic of arrangement 300 selected from the group consisting of: the source data files 200 associated with the arrangement; the modifications made to the arrangement by the user; the type of source data files 200 associated with the arrangement; the intended usage location (e.g. geographic location and/or venue) of output file 50; and combinations of these. In some embodiments, algorithm 115 determines the purchase cost based on a user parameter, such as a parameter selected from the group consisting of: the type of level of the user’s subscription to system 10; the user’s geographic location; the number of times the user has purchased an output file 50; and combinations of these. In some embodiments, algorithm 115 is biased toward determining a lower purchase cost, for example to increase usage of system 10 in a particular geography, algorithm 115 can determine lower costs in that geography. In some embodiments, system 10 is configured to offer discounted prices, for example if the user agrees to share data for market research.

GUI 550 can comprise player control 5520, which can include a visual representation of a waveform, waveform display 5521. Player control 5520 can include play button 5523. Play button 5523 can be configured to play and/or pause playback of an arrangement 300 (e.g. to start or stop playback if playback is stopped or running, respectively). In some embodiments, system 10 is configured to produce an output file 50 based on an arrangement 300 in response to the user selecting play button 5523. System 10 can be configured to produce the output file 50 and subsequently play the output file 50 (e.g. via speakers of user interface 500). In some embodiments, system 10 is configured to produce a portion of output file 50 (e.g. a first portion of output file 50), and simultaneous with playing that first portion, continue to produce the remaining portions, such that by the time the first portion has completed playback, a subsequent portion is produced and ready for playback. Player control 5520 can include a playback positional indicator, indicator 5522. Indicator 5522 can comprise a shaded region of a waveform display 5521, where the current playback location is indicated by the leading edge of the shaded region. Player control 5520 can also include an information display, time display 5524, indicating the length of arrangement 300.

Referring specifically to FIG. 2, GUI 550 is shown displaying an overview page Pov that includes one or more of the controls previously described, as well as general information relating to an arrangement 300. The overview icon of tab control 5510 is shaded to indicate the page P_{OV} is displayed. Page P_{OV} includes an information display area, display area 5530. Within display area 5530, file icons 5531 are displayed, each representing a source data file 200 which has been incorporated into arrangement 300 (e.g. into an initial arrangement 300_{I}). To edit a portion of arrangement 300, the user can select a tab within tab control 5510 to cause a page to be displayed comprising one or more controls for editing arrangement 300, as described herein.

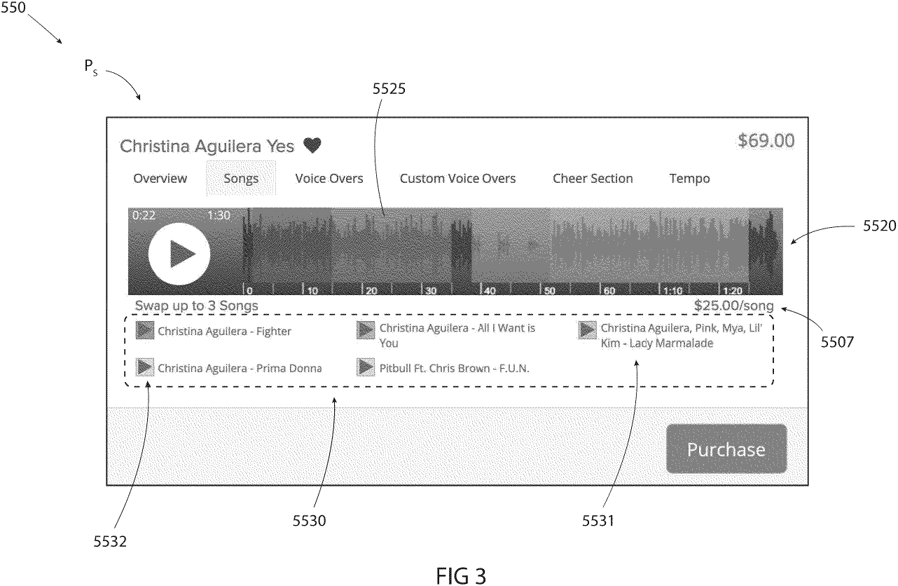

Referring specifically to FIG. 3, GUI 550 is shown displaying a songs page P_{S} that includes one or more of the controls previously described, as well as information regarding the location of each source data file 200 within arrangement 300. When displayed on page P_{S}, player control 5520 can include one or more overlays, overlays 5525. Overlays 5525 can indicate to the user the location of each source data file 200 within arrangement 300. For example, each overlay 5525 can be color coded to match a corresponding color displayed on each icon 5531 within display area 5530. In some embodiments, overlay 5525 can indicate to the user a region of arrangement 300 comprising multiple source data files 200, for example one or more source data files 200 comprising audio files, as well as one or more modifying source files 200_{M}. In some embodiments, overlay 5525 can indicate a region of arrangement 300 which can be replaced (e.g. by an alternate source data file 200 comprising the same length as the indicated region) as described herein. In some embodiments, overlay 5525 can indicate the status of a license of a portion of arrangement 300, for example if a license would not be available to the user for that portion of arrangement 300, such as an unavailability based on the geographical location of the user.

From songs page P_{S}, the user can select one or more source data files 200 to be replaced (also referred to as a “swap” herein) in arrangement 300. Songs page Ps can include a second cost display, cost display 5507 shown. Cost display 5507 can comprise an information display indicating the amount that would be added to the purchase cost (e.g. added to the amount shown as cost display 5505 described herein) of output file 50 based on a proposed user modification to arrangement 300. For example, cost display 5507 can indicate the additional cost associated with swapping one or more source data files 200 and/or the cost of additional licenses required based on the swap. Each icon 5531 can comprise a play button 5532. Play button 5532 can be configured to initiate playback of the output file 50, for example starting from the beginning of the associated source data file 200 or from an amount of time prior to the beginning of the associated source data file 200 (e.g. a predetermined amount of time or a user defined amount of time). Additionally, play button 5532 can be configured to stop playback, for example, if playback is already initiated.

In some embodiments, algorithm 115 of system 10 is configured to analyze a swap (e.g. a user-initiated swap), such as to provide to a user qualitative and/or quantitative information related to the impact of the swap. Algorithm 115 can be configured to analyze the swap before (e.g. while the swap is pending) and/or after one or more source data files 200 are swapped within arrangement 300 (e.g. a first source data file 200_{OG} is replaced with a second source data file 200_{SW}). In some embodiments, one or more properties of source data file 200_{OG} are compared with similar properties of source data file 200_{SW}. Algorithm 115 can be configured to alert the user if one or more properties differ between files 200_{OG} and 200_{SW}. For example, if the popularity (among users of system 10) of source data file 200_{SW} is less than the popularity of source data file 200_{OG}, algorithm 115 can notify the user a less popular file was (or will be) swapped with a more popular file. In some embodiments, the user is alerted prior to the swap, and the swap can be canceled by the user based on the alert.

Additionally or alternatively, algorithm 115 can be configured to compare the length of files 200_{OG} and 200_{SW}. If the length of the two files differs (e.g. differs beyond an acceptable threshold), algorithm 115 can alert the user that the pending swap would alter the overall length of arrangement 300. Algorithm 115 can provide (e.g. via GUI 550) the user the option to cancel or proceed with the swap. In some embodiments, if a swapped source data file 200_{SW} does comprise a duration that differs from the original source data file 200_{OG}, algorithm 115 can prompt the user to select an option to handle the change in length of arrangement 300 caused by the swap. For example, options can include options selected from the group consisting of: allow the length of arrangement 300 to change; adjust the tempo of one/or more portions of arrangement 300 to maintain the original duration (e.g. algorithm 115 automatically adjusts the tempo); adjust the position of one or more source data files 200 following the swapped data file 200_{SW} in arrangement 300 to maintain the original duration; and combinations of these.

In some embodiments, algorithm 115 is configured to automatically swap one or more files 200_{OG} based on the availability of licenses to files 200_{OG}. For example, if an arrangement 300 comprises one or more files 200_{OG} unavailable for license in a particular geographic location (e.g. a location indicated by the user as an intended use location), algorithm 115 can automatically (e.g. when triggered by a user action, such as a single “click”) swap any unavailable files 200_{OG} with similar files 200_{SW} available with the appropriate licenses. In some embodiments, algorithm 115 swaps files comprising similar attributes.

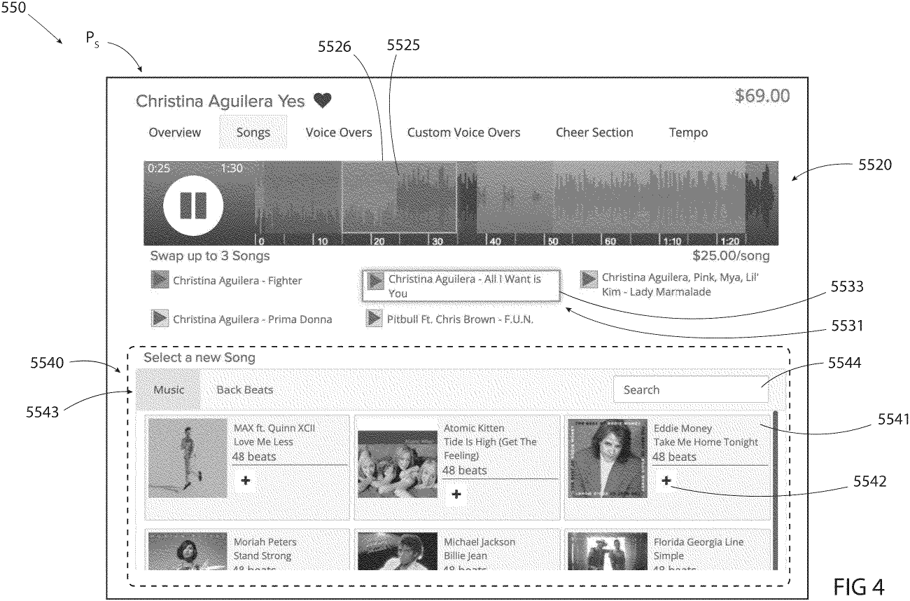

Referring specifically to FIG. 4, GUI 550 is shown displaying another embodiment of songs page P_{S} that includes one or more of the controls previously described, as well as information regarding the location of each source data file 200 within arrangement 300. The user can select a source data file 200 for replacement by selecting either or both of an overlay 5525 of player control 5520 and/or an icon 5531 representing the desired source data file 200. Once a data file has been selected (data file 200_{S} herein), either or both of the associated overlay 5525 and/or icon 5531 can be highlighted to the user as selected, such as within an indicator 5526 and/or 5533, respectively. For example, indicators 5526 and/or 5533 can comprise a border surrounding the associated overlay 5525 and/or icon 5531, respectively, as shown. An additional information display area can be displayed, selection area 5540. Selection area 5540 can display a set of one or more icons 5541 associated with one or more source data files 200 available to the user to swap with the selected file 200_{S} from arrangement 300.

Each icon 5541 can display information relating to the associated source data file 200, such as the title, artist, and/or the length of the file (e.g. the number of beats of the file). Each icon 5541 can comprise a control, add button 5542. Add button 5542 can be configured to swap the associated source data file 200 with the selected file 200_{S}. In some embodiments, by selecting an icon 5541, playback of output file 50 can be initiated incorporating the source data file 200 represented by icon 5541 in place of the previously selected file 200_{S}. In this configuration, the user can preview one or more file replacements before selecting which, if any, replacement source data file 200 is to be swapped with the selected file 200_{S}. If the user decides to swap a file, add button 5542 can be selected by the user to initiate the swap. After system 10 has processed the swap, selection area 5540 can be removed from page P_{S}. In some embodiments, prior to and/or after selecting a file to swap, the user can select an alternate file 200_{S} (e.g. by selecting an alternate overlay 5525 and/or icon 5531). By selecting an alternate file 200_{S}, the one or more icons 5541 can be updated to represent a new set of source data files 200 available to the user to swap with the selected file 200_{S}.

Algorithm 115 can be configured to determine a set of source data files 200 to display based on the selected file 200_{S}. In some embodiments, algorithm 115 determines the set of one or more source data files 200 (e.g. from library 120 of source data files 200) based on the length of the source data files 200 and the length of the selected file 200_{S} (e.g. to relatively match the length of the files). In some embodiments, each file 200_{S} comprises a set of one or more source data files 200 predetermined (e.g. predetermined by an algorithm and/or a host of system 10) to be available to swap with that file. In some embodiments, this predetermined set of swappable files is specific to the file 200_{S} independent of the specific arrangement 300. Alternatively or additionally, the predetermined set of swappable files is specific to the combination of file 200_{S} and its specific arrangement 300. For example, in a first arrangement 300, a file 200_{S} can have an associated set of swappable files (e.g. files A, B and C), whereas in a second arrangement, the same file 200_{S} (e.g. the same source data file 200) can have a different associated set of swappable files (e.g. files B, D, and E).

In some embodiments, selection area 5540 can comprise a filter control, tab filter 5543. Tab filter 5543 can comprise one or more icons configured to filter the set of source data files 200 displayed. For example, an icon can be configured to filter the set of source data files 200 such that only musical-based source data files 200 are displayed. In another example, an icon can be configured to filter the set of source data files 200 such that only source data files 200 comprising a “backbeat” are displayed (e.g. a source data file 200 comprising a track including only a beat recommended to perform a cheer or chant over). Additionally or alternatively, selection area 5540 can comprise a search control 5544. Search control 5544 can be configured such that the user can input (e.g. type) a search term into search control 5544, and the set of source data files 200 displayed is limited to files that match the search criteria.

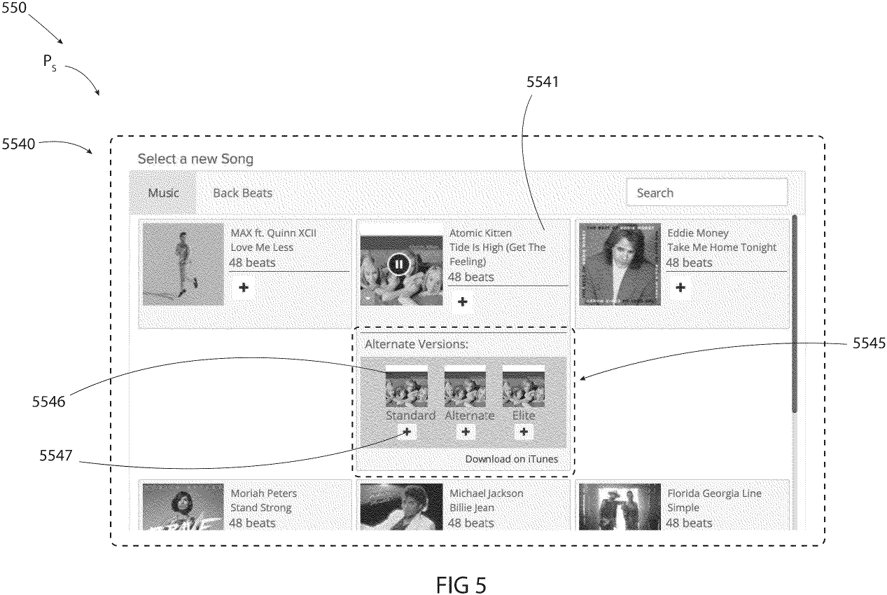

Referring specifically to FIG. 5, a portion of songs page P_{S} of GUI 550 is illustrated. In some embodiments, library 120 of system 10 comprises one or more sets of source data files 200_{A}, each set comprising alternate versions of a standard source data file 200_{SD}. In some embodiments, when the user selects an icon 5541 of selection area 5540, an additional selection area 5545 is displayed. Additional selection area 5545 can display one or more icons 5546 representing one or more source data files 200_{A} each comprising an alternate version of the standard source data file 200_{SD} represented by icon 5541. Each icon 5546 can comprise a control, add button 5547. Add button 5547 can be configured to swap the associated source data file 200 (e.g. source data file 200_{SD} or 200_{A}) with the selected file 200_{S}, similar to the function of add button 5542 as described herein. In some embodiments, icon 5541 remains the same (e.g. the information displayed by the icon does not change) when an alternate version is selected. In other words, icon 5541 displays information relevant to the group of source data files 200 (e.g. source data file 200_{SD} and any alternate files 200_{A} available). In some embodiments, one or more of the alternate source data files 200_{A} includes a cost, such as a cost that would increase the purchase price of output file 50 were the source data file 200_{A} to be included in arrangement 300. In some embodiments, algorithm 115 determines the set of one or more source data files 200_{A} (e.g. from library 120 of source data files) based on the length of the source data files 200_{A} and the length of selected file 200_{SD} (e.g. when library 120 comprises source data files 200_{A} of varying lengths associated with a standard source data file 200_{SD}).

In some embodiments, an icon of GUI 550 representing a source data file 200 (e.g. icons 5541 and/or 5546) can comprise one or more player controls (not shown), such as one or more controls configured to allow the user to initiate playback of the associated source data file 200 (e.g. to initiate playback of the associated source data file 200 without associating the file with arrangement 300).

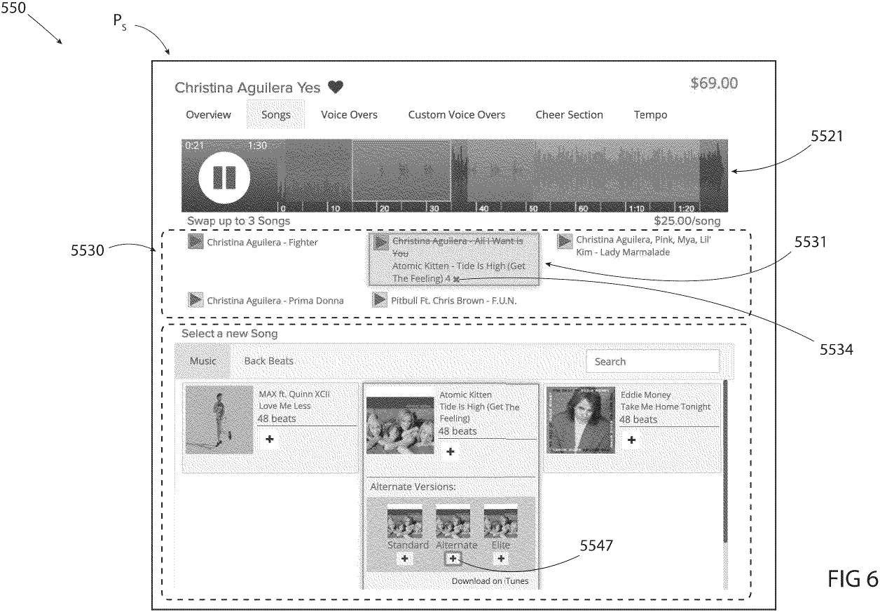

Referring specifically to FIG. 6, GUI 550 is shown displaying another embodiment of songs page P_{S} that includes one or more of the controls previously described, as well as information regarding the location of each source data file 200 within arrangement 300. After the user has selected an add button (e.g. add button 5542 or 5547), system 10 can replace file 200_{S} with the newly selected source data file, file 200_{N}. Display area 5530 can display information related to the file swap, for example, by indicating both the name of file 200_{S} and 200_{N} within icon 5531, as shown in FIG. 6. In some embodiments, the name of replaced file 200_{S} can be displayed in a crossed-out fashion, or in another fashion meant to indicate the file was replaced. The information displayed in waveform display 5521 (e.g. a portion of the waveform shape displayed) can be updated to match the waveform of new file 200_{N}. In some embodiments, after a file has been replaced, icon 5531 can comprise cancel button 5534. Cancel button 5534 can be configured to undo the file swap indicated by the information displayed on icon 5531 by replacing file 200_{N}with the original file 200_{S} in arrangement 300.

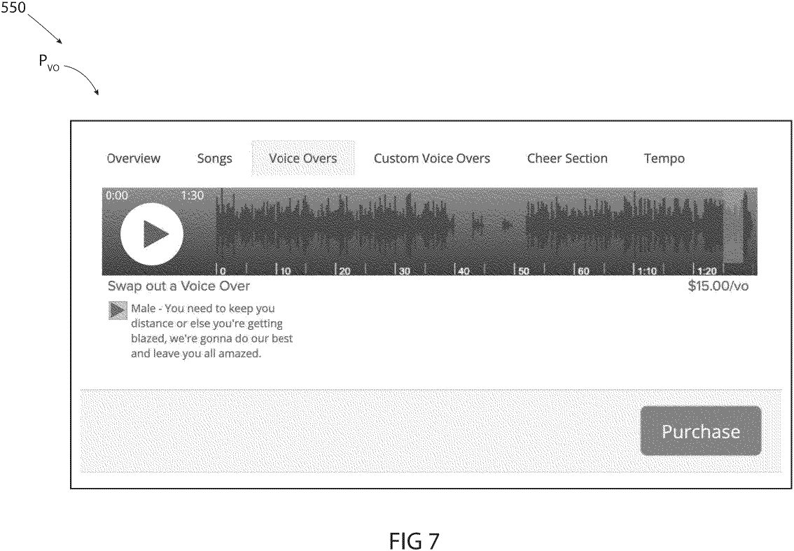

Referring specifically to FIG. 7, GUI 550 is shown displaying a voiceover page P_{VO} that includes one or more of the controls previously described, as well as information regarding the location one or more of the source data files 200 within arrangement 300. Page P_{VO} can comprise similar information, controls, and/or enable similar functionality as page P_{S} described herein. Page P_{VO} can be configured to allow the user to replace one or more voice-over-based source data files 200 of arrangement 300. Voice-over-based source data files 200 can comprise audio files comprising voice-over audio for use in an audio mix. An information display of the voice-over-based source data files 200 included in arrangement 300 can be displayed on Page Pvo, as shown.

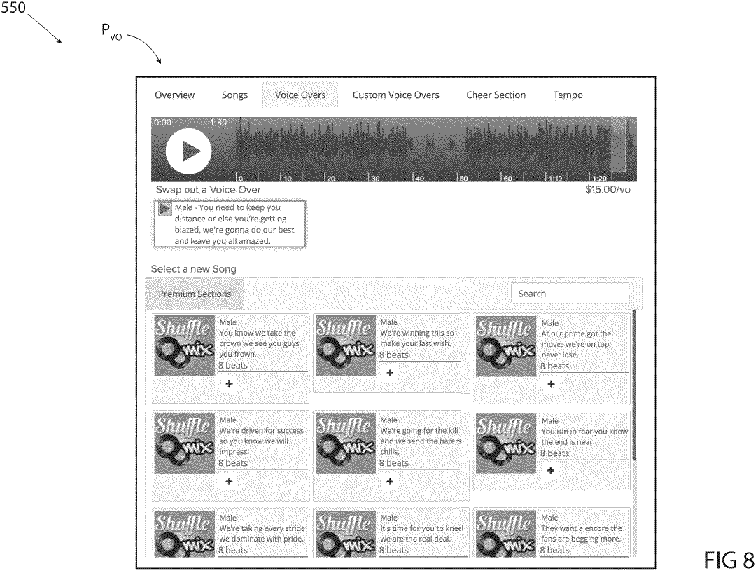

Referring specifically to FIG. 8, GUI 550 is shown displaying another embodiment of voiceover page P_{VO} that includes one or more of the controls previously described, as well as information regarding the location one or more of the source data files 200 within arrangement 300. A selection area is displayed including a set of one or more icons associated with one or more voice-over-based source data files 200 that are available to the user to swap with a selected file 200_{S} from arrangement 300.

In some embodiments, the selection area includes a set of one or more icons associated with one or more sound-effect-based source data files 200, or other source data files configured to be added to arrangement 300 (instead of replacing an existing selected source data file 200_{S}). In some embodiments, a single icon may represent two or more individual source data files 200. For example, the user can add a series of sound effects to arrangement 300 to coordinate with a particular skill (e.g. a kick double basket toss) in the associated choreographed routine. This multiple effect add function can be enabled via a single icon associated with the series of sound effects. As described herein, each icon can comprise playback controls configured to allow the user to initiate playback of the one or more source data files 200. Additional source data files 200 can be added to arrangement 300 by dragging (e.g. via a finger or stylus and/or by click and drag with a mouse) the associated icon onto the arrangement. In some embodiments, sound-effect-based source data files 200 can be swapped (once added to arrangement 300), as described herein.

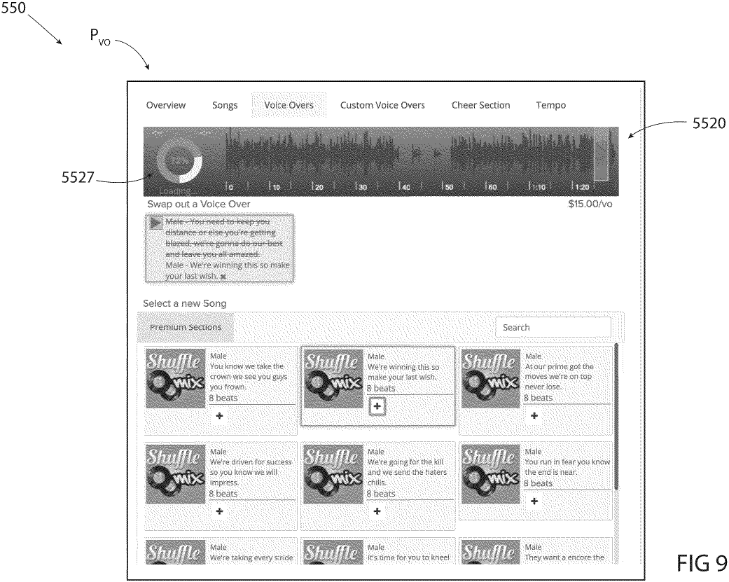

Referring specifically to FIG. 9, GUI 550 is shown displaying another embodiment of voiceover page P_{VO} that includes one or more of the controls previously described, as well as information regarding the location one or more of the source data files 200 within arrangement 300. Information is displayed representing a file swap that the user has initiated, as described herein. In some embodiments, after a file swap has been initiated by the user, player control 5520 can display progress indicator 5527. Progress indicator 5527 can be configured to indicate to the user the status (e.g. the progress) of the production of output file 50 based on the modified arrangement 300. In some embodiments, after the production has reached a particular level of completion (e.g. 100% completion or completion to a point where output file 50 can be played starting from the beginning of the new file 200_{N-} ), the output file begins to play automatically.

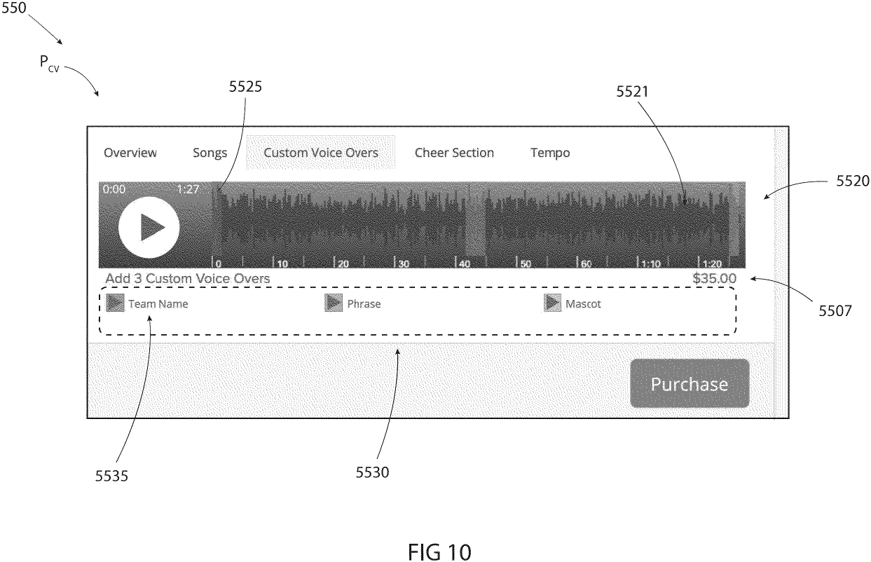

Referring specifically to FIG. 10, GUI 550 is shown displaying a custom voiceover page P_{CV} that includes one or more of the controls previously described. In some embodiments, system 10 is configured to allow the user to include one or more custom source data files 200, custom file 200_{C}, in arrangement 300. In some embodiments, system 10 enables a first user to request the addition of custom file 200_{C} to library 200, such as a request that is fulfilled by a host and/or a second user of system 10. For example, the user can request a custom file 200c comprising an audio file of a voice-over including the user’s “team name” and/or other user-specific information. A host of system 10 can generate the requested custom file 220_{C} (e.g. record the audio file) and add file 220_{C} to library 120 for the user to incorporate into arrangement 300. Additionally or alternatively, system 10 can comprise an upload and/or a record function such that the user can upload and/or record one or more custom files 200_{C}. In some embodiments, custom file 200_{C} comprises a custom vocal recording, such as a recording created by and/or commissioned by a host of system 10 (e.g. created by the manufacturer and/or supplier of system 10). In some embodiments, custom file 200_{C} comprises a computer-generated file (e.g. using text to speech processing). Alternatively, custom file 200_{C} can comprise a non-computer-generated file, such as a file including a recording of a voice (e.g. a single person’s voice or a collection of voices from multiple people). In some embodiments, a custom file 200_{C} comprises a voice recording that has been post-processed (e.g. after the recording) to increase the quality or otherwise alter the characteristics of the recording, such as via one or more audio filters and/or other effects applied to the recording by a host and/or algorithm 115 of system 10 prior to adding custom file 200c to library 120 and/or arrangement 300.

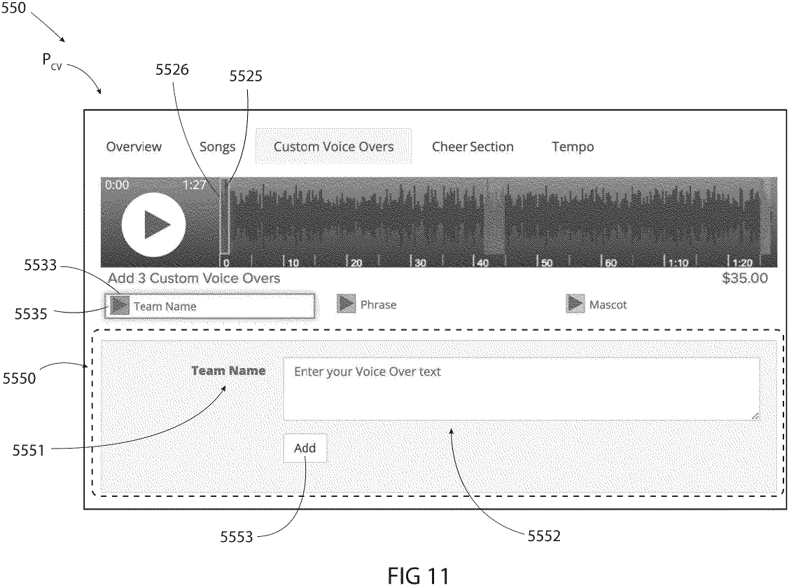

In some embodiments, waveform display 5521 includes one or more overlays 5525 that can indicate available locations within arrangement 300 where custom files 200_{C} can be positioned. Information display area 5530 can include one or more action buttons 5535, each representing a location within arrangement 300 where a custom file 200_{C} can be included (e.g. the locations indicated by overlays 5525). Action button 5535 can be configured to display an input dialog that enables the user to request custom file 200_{C}, for example, as described herein in reference to FIG. 11. In some embodiments, cost display 5507 indicates to the user the amount that would be added to the purchase cost of output file 50 (e.g. added to the amount shown by cost display 5505 described herein) based on the addition of a custom file 200_{C}.

Referring specifically to FIG. 11, GUI 550 is shown displaying another embodiment of a custom voiceover page P_{CV} that includes one or more of the controls previously described, as well as an input dialog for requesting a custom file 200_{C}. If the user selects to request a custom file 200_{C} (by either selecting an action button 5535 and/or overlay 5525 correlating to the location of the desired custom file 200_{C} relative to arrangement 300), input dialog 5550 is displayed on page P_{CV}. Input dialog 5550 can include an information display, type display 5551. Type display 5551 can indicate to the user the type of custom voice-over they are requesting, for example, a voice-over announcing the user’s “team name” and/or other user-specific information. Input dialog 5550 can also include a user input area, text box 5552, and a confirmation control, add button 5553. The user can input text information into text box 5552, for example, “Melbourne High School”. In some embodiments, algorithm 115 of system 10 analyzes the text input to confirm the requested custom file 200c will fit in the location indicated within arrangement 300. For example, if the indicated space comprises a length of two beats, and the input text would require more than two beats to vocalize, a warning message can be displayed to the user. After the user has input the desired text (e.g. without activating a warning message), the user can select add button 5553 to submit the request to a host of system 10.

In some embodiments, after the user purchases an output file 50 corresponding to an arrangement 300, if arrangement 300 includes one or more custom files 200_{C}, the user can be alerted by system 10 (e.g. via email) once the custom file(s) 200_{C} have become available. In some embodiments, system 10 provides to the user a first output file 50 which does not include the one or more custom files 200_{C}. Once the complete output file 50 is available (e.g. including the one or more custom files 200_{C}), the complete output file 50 is provided to the user (e.g. the user is notified that the complete output file 50 is available for download).

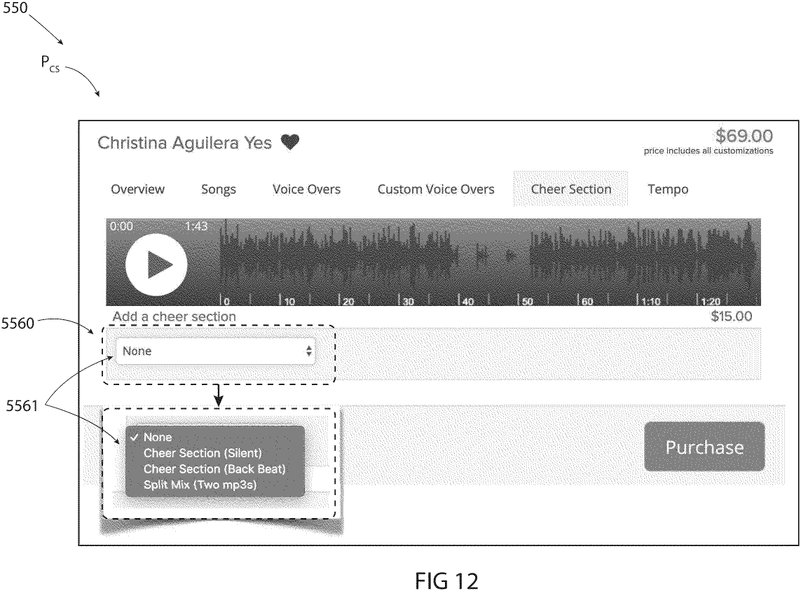

Referring specifically to FIG. 12, GUI 550 is shown displaying cheer section page P_{CS} that includes one or more of the controls previously described, as well as a dialog for inserting a cheer section into arrangement 300. In some instances, a cheerleading routine (or other performance routine) can include a portion where no musical accompaniment or minimal musical accompaniment is desired, this portion referred to as a “cheer section” (e.g. a portion in which the team typically chants a team cheer or anthem). In some embodiments, system 10 is configured to incorporate the cheer section into arrangement 300, as described herein. Page P_{CS} includes selection control 5560. Selection control 5560 can comprise a first menu, menu 5561, for example, a drop-down menu as shown, providing multiple options to the user regarding a cheer section of an arrangement 300. A first option can comprise an arrangement 300 with no cheer section. For arrangements 300 with a cheer section, output file 50 can comprise one or more of the following: a file with a portion comprising no sound; a file with a portion comprising only a backbeat (e.g. a source data file 200 comprising a track including a beat suitable to perform a cheer or chant over); or a “split mix” comprising two files, for example, a first file to be played prior to the cheer section of a routine, and a second file to be started after the cheer section has completed. In some embodiments, system 10 is configured to allow the user to upload and/or record information to be stored by system 10 as a data file 200, such as a file that is subsequently placed in the “cheer section” of arrangement 300 (e.g. instead of a source data file 200 comprising a backbeat).

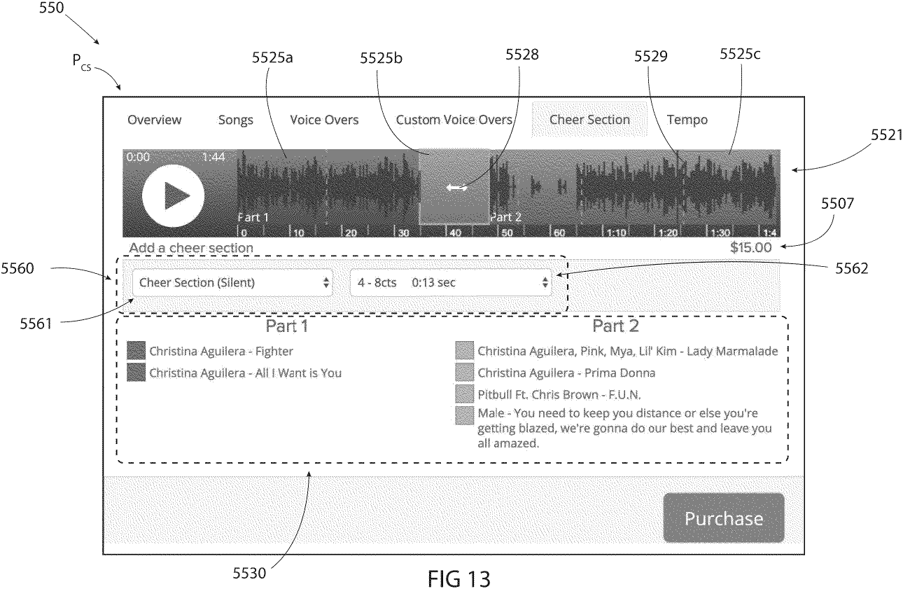

Referring specifically to FIG. 13, GUI 550 is shown displaying another embodiment of a cheer section page P_{CS} that includes one or more of the controls previously described, as well as a dialog for inserting a cheer section into arrangement 300. If the user selects to add a cheer section to arrangement 300, page P_{cs} can display an additional menu, menu 5562, which can provide options to the user regarding the length of the cheer section (e.g. when the selected cheer section comprises a silent cheer section). Waveform display 5521 can include three overlays 5525, overlay 5525a indicating the portion of arrangement 300 prior to the cheer section, overlay 5525b indicating the cheer section, and overlay 5525c indicating the portion of arrangement 300 following the cheer section. Information display area 5530 can display multiple (e.g. two) lists of the source data files 200 included in arrangement 300, such as a list of the files associated with the portion of arrangement 300 prior to the cheer section (e.g. “Part 1”), and a list of the files associated with the portion of arrangement 300 following the cheer section (e.g. “Part 2”). In some embodiments, cost display 5507 indicates to the user the amount that would be added to the purchase cost of output file 50 (e.g. added to the amount shown by cost display 5505 described herein) based on the addition of a cheer section. Overlay 5525b can include drag control 5528. Drag control 5528 can comprise arrows (as shown) to indicate to the user that the position of the cheer section can be adjusted by the user within arrangement 300. Waveform display 5521 can include one or more indicators 5528, indicating the start and end points of the source data files 200 of arrangement 300 (e.g. the location where a first file ends and a second file begins). In some embodiments, as the user repositions the cheer section (e.g. using drag control 5528), the position of the cheer section automatically “snaps” (i.e. relocates) to the closest indicator 5529, such that the cheer section is automatically inserted between two source data files 200 (e.g. such that a source data file 200 is not split or otherwise interrupted in an undesired manner). In some embodiments, one or more source data files 200 include one or more points acceptable for the inclusion of a cheer section. Indicators 5529 can be displayed to indicate these points as well.

In some embodiments, drag control 5528 is configured to allow the user to reorder source data files 200 within arrangement 300. For example, the user can select (e.g. “click on”) a source data file 200 (e.g. as indicated by an overlay 5525, not shown, but described in reference to FIG. 3 and otherwise herein), and system 10 can display drag control 5528 relative to the selected source data file. In some embodiments, algorithm 115 of system 10 is configured to determine where a source data file 200 is placed after the user repositions the file using drag control 5528. For example, algorithm 115 can determine the placement based on a set of rules. Placement rules can be based on factors selected from the group consisting of: the position where drag control 5528 was released relative to an indicator 5529; the position of an overlay (e.g. overlay 5525b) relative to an indicator 5529; the direction of movement of a source data file 200 (e.g. left (earlier) or right (later)) in the arrangement; the starting position of the source data file being moved; the determined ending location of the file being moved; and combinations of these. In some embodiments, a set of placement rules provided are based on the direction of movement of the source data file 200. For example, a first set of rules can apply to moving a file to the right (later in arrangement 300), and a second set of rules (e.g. a set containing at least one rule unique to that set) can apply to moving a file to the left (earlier in arrangement 300). In some embodiments, one or more rules provided are based on a threshold, for example the threshold of the amount a first icon (e.g. an icon being dragged) overlaps a second icon. For example, a threshold of an amount of overlap of two icons can comprise a threshold of at least 1%, at least 25%, or at least 50% overlap.

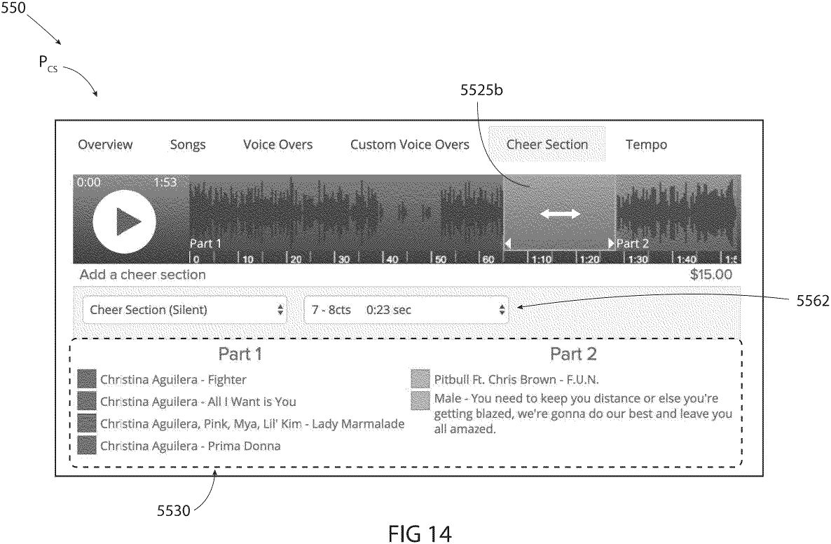

Referring specifically to FIG. 14, GUI 550 is shown displaying another embodiment of a cheer section page P_{cs} that includes one or more of the controls previously described. The position of the cheer section of FIG. 14 has been moved and the length has been increased, as indicated by overlay 5525b and menu 5562. The lists displayed in information display 5530 have also been updated based on the new location of the cheer section.

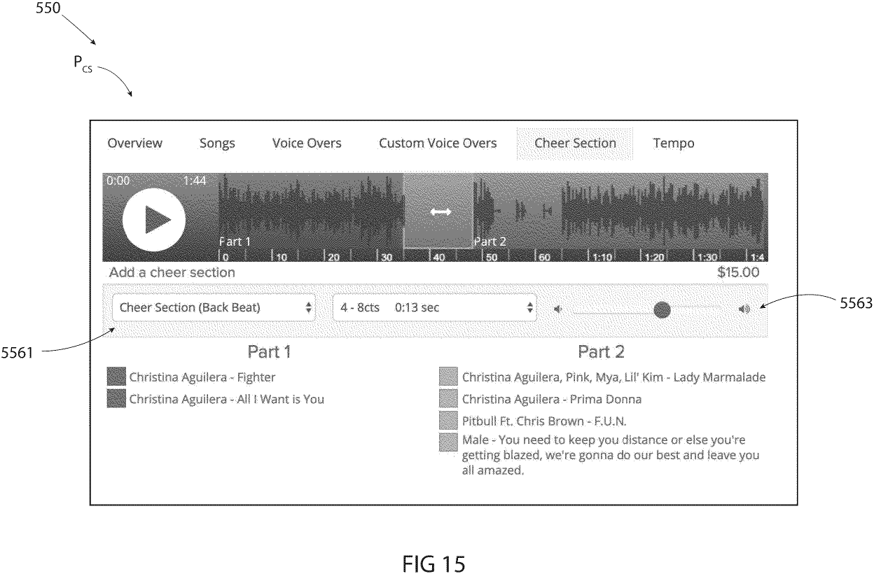

Referring specifically to FIG. 15, GUI 550 is shown displaying another embodiment of a cheer section page P_{cs} that includes one or more of the controls previously described, including a control for editing a property of a source data file. When the user selects to include a cheer section comprising a backbeat (as indicated by menu 5561), a property adjustment control, volume control 5563 can be displayed. Volume control 5563 can be configured to adjust the volume of the backbeat (e.g. the volume of the source data file 200 comprising the backbeat included in arrangement 300) relative to the other source data files 200 of arrangement 300.

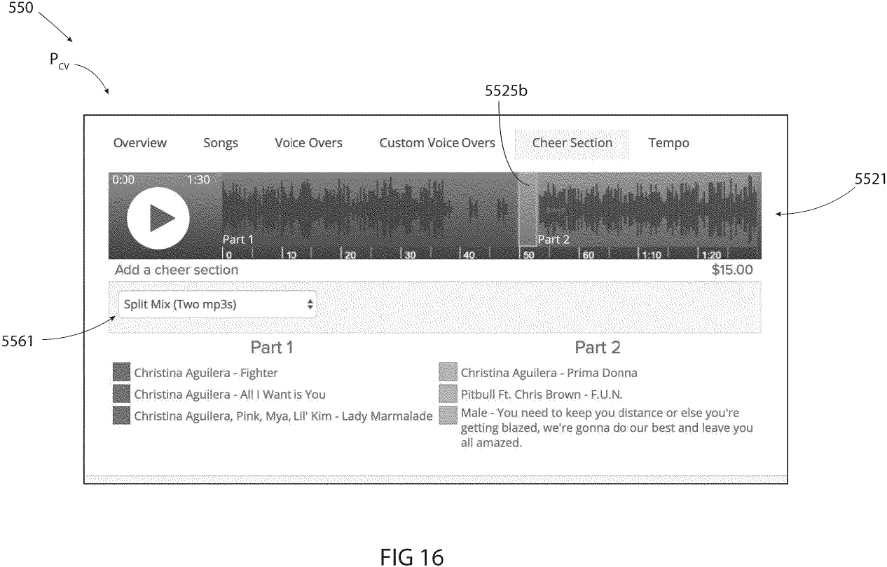

Referring specifically to FIG. 16, GUI 550 is shown displaying another embodiment of a cheer section page P_{cs} that includes one or more of the controls previously described. When the user selects to include a cheer section where output file 50 is provided as a split mix (as indicated by menu 5561), overlay 5525b can be displayed on waveform display 5521 to indicate where arrangement 300 will be split. In some embodiments, algorithm 115 is configured to automatically include an additional source data file 200 comprising an “ending sound” and/or an “intro sound” to the end of the first portion and/or beginning of the second portion, respectively. In some embodiments, these additional source data files 200 alter the duration of arrangement 300. Algorithm 115 of system 10 can be configured to alter one or more source data files 200 and/or attributes of arrangement 300 to accommodate these additional source data files 200 without altering the duration of the arrangement (e.g. to adjust the tempo). In some embodiments, algorithm 115 is configured to adjust the duration of an arrangement by applying a time-stretch function to at least a portion of the arrangement (e.g. a function that can increase or decrease the duration of a portion of the arrangement). In some embodiments, the time-stretch function adjusts the starting position (i.e. the start time) of each source data file 200 within the time-stretched arrangement 300 to maintain the timing relationships between each source data file 200 before and after applying the time-stretch function. In some embodiments, arrangement 300 comprises two or more overlapping source data files 200. In these embodiments, algorithm 115 can be configured to maintain timing alignment between overlapping files while performing a time-stretch function. For example, arrangement 300 can comprise overlapping audio and video source data files 200, and both the audio and video files can be time-stretched to maintain synchronization between the files. Alternatively, a first type of overlapping source data file 200 (e.g. audio files) can be modified (e.g. time-stretched), and a second type of overlapping source data files 200 (e.g. video files) can be left unmodified, and the synchronization between the files can be allowed to “slip” out of sync. In some embodiments, algorithm 115 is configured to maintain the length of an arrangement 300 (e.g. a user defined length) by adjusting one or more properties of one or more of the source data files 200 associated with the arrangement 300 (e.g. by time-stretching or time-compressing one or more of the source data files 200 of the arrangement 300), as the user adds or removes one or more source data files 200 to the arrangement 300. In some embodiments, if the required time-stretch and/or time-compression required to maintain the length based on a user-initiated change is above a threshold, system 10 is configured to alert the user.

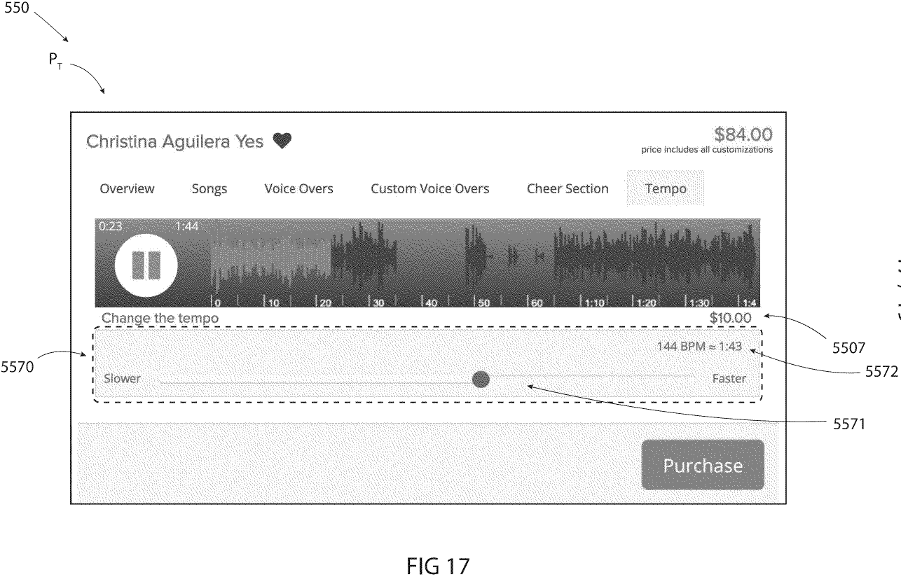

Referring specifically to FIG. 17, GUI 550 is shown displaying a tempo modification page P_{T} that includes one or more of the controls previously described, including a control for editing a property of arrangement 300. Page P_{T} can include a control for modifying one or more properties of arrangement 300, property control 5570. Property control 5570 can include tempo control 5571. Tempo control 5571 can comprise a control that is configured to allow the user to adjust the overall tempo of arrangement 300 (e.g. to adjust the tempo of each source data file 200 included in arrangement 300, such as to adjust the tempo of output file 50). In some embodiments, tempo control 5571 is configured to allow the user to adjust the tempo of at least a portion of at least one source data file 200 of arrangement 300. In some embodiments, cost display 5507 indicates to the user the amount that would be added to the purchase cost of output file 50 (e.g. added to the amount shown by cost display 5505 described herein) based on a modification of the tempo of arrangement 300. Property control 5570 can include an information display, for example, tempo display 5572. Tempo display 5572 can indicate the tempo (e.g. beats per minute) of arrangement 300, as well as the duration of output file 50 based on the displayed tempo of arrangement 300. In some embodiments, tempo display 5572 can display the change in the tempo and/or overall duration of arrangement 300 as a result of a tempo change. Tempo display 5572 can display information regarding tempo changes made to arrangement 300 via other mechanisms of system 10 described herein (e.g. user initiated and/or automatic tempo changes that may have already been performed to arrangement 300). System 10 can be configured to alert the user if an automatic tempo adjustment is being modified via tempo control 5571.

Referring specifically to FIG. 18, GUI 550 is shown displaying a purchase summary page P_{PS} that includes one or more of the controls previously described, including a summary of modifications made to arrangement 300. Page P_{PS} can include summary display 5580. Summary display 5580 can display information relating to one or more customizations made to arrangement 300. Summary display 5580 can include one or more icons, icons 5581, linking to one or more pages described herein. In the example shown, the user has not selected to add any custom voice-overs, and icon 5581 links to page P_{cv}, where the user can add a custom voice-over if desired. Cost display 5505 can indicate the final purchase cost of output file 50, including any additional costs incurred from the modifications made to arrangement 300.

In some embodiments, system 10 is configured to provide one or more licenses to the user, for example, master and/or mechanical licenses for the use (e.g. public use) of output file 50. Page P_{PS} can include license control 5590. License control 5590 can include one or more inputs and/or menus configured to allow the user to indicate license requirements and/or to identify the recipient of the license. Algorithm 115 of system 10 can be configured to calculate the cost for a user to license output file 50, and/or any costs owed by the manufacturer of system 10 to sell output file 50. Algorithm 115 can determine the licensing costs based on the costs associated with each source data file 200 included in arrangement 300, as well as any user modifications made to arrangement 300. For example, if the user has swapped a source data file 200 comprising licensed media for a source data file 200 comprising license-free media (e.g. a royalty-free song), system 10 can recalculate the overall cost based on the change. In some embodiments, system 10 can provide various types of license for purchase for an output file 50, for example a synchronization license (e.g. in addition to a usage license, a synchronization license allows the user to synchronize output file 50 comprising an audio with video, such as for a television or internet broadcast). Additionally or alternatively, system 10 can provide a license to perform an act based on output file 50 (e.g. when output file 50 comprises choreography instruction), and/or to perform an act in a synchronized manner with output file 50 (e.g. when output file 50 comprises a musical score intended to be played during the performance of a choreographed routine). In some embodiments, summary display 5580 can display one or more indicators indicative of the license status of output file 50. For example, if all source data files 200 associated with output file 50 are licensed for synchronization, an indicator showing that output file 50 comes with a synchronization license can be displayed.

Page P_{PS} can include back button 5508. Back button 5508 can be configured to navigate GUI 550 to the page previously displayed, for example, the page from which the user selected purchase button 5506. Page P_{PS} can also include a button configured to add output file 50 to an online shopping cart, cart button 5509.

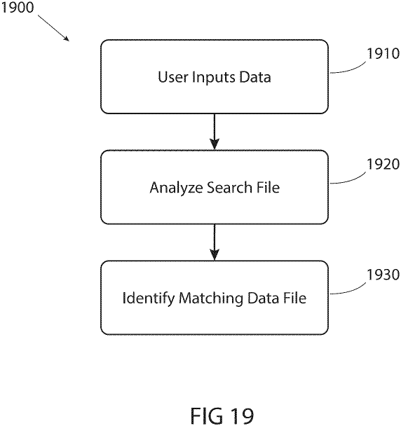

Referring now to FIG. 19, a method of searching a library of source data based on a user input is illustrated, consistent with the present inventive concepts. Method 1900 of FIG. 19 can be performed via algorithm 115 of system 10 described herein. In Step 1910, the user inputs data that system 10 uses to produce a search file SF. Search file SF can comprise an audio file, for example when the user records audio via an input device of system 10. Alternatively or additionally, search file SF can comprise a text file, a video file, and/or another file comprising information input by the user.

In Step 1920, algorithm 115 analyzes search file SF. Algorithm 115 can be configured to identify one or more characteristics of the input file, for example characteristics selected from the group consisting of: one or more visual and/or audio markers; one or more musical characteristics such as meter and/or pitch; motion characteristics, such as motion determined by a computer vision algorithm; linguistic characteristics, such as verbal cues identified by a speech analyzer; and combinations of these.

In Step 1930, algorithm 115 identifies one or more source data files based on the identified characteristics of the search file SF. In some embodiments, system 10 presents the results to the user, and algorithm 115 is configured to incorporate the user selection in the analysis of future search files SF. In other words, algorithm 115 can comprise an artificial intelligence or other learning algorithm configured to automatically improve based on information collected by system 10 over time. In some embodiments, algorithm 115 can comprise a bias. For example, algorithm 115 can comprise a bias toward identifying popular source data files 200 (e.g. files popular among the users of system 10). Additionally or alternatively, algorithm 115 can comprise a bias toward particular source data files 200 based on the cost associated with the file (e.g. a bias toward relatively expensive source data files 200 or relatively cheap or free source data files 200). In some embodiments, algorithm 115 comprises a bias based off of a user preference, such as a user preference stored as user data 140.

As an example of method 1900, the user can record sounds (e.g. a beat made by making verbal sounds and/or tapping on a surface) and algorithm 115 can identify a source data file 200 with a similar beat. As another example, the use can upload and/or record a video of an athlete performing a skill (e.g. a toe touch), and algorithm 115 can analyze the search file SF to identify the skill, and identify one or more source data files 200 associated with the skill.

While the present inventive concepts have been particularly shown and described above with reference to example embodiments thereof, it will be understood by those of ordinary skill in the art, that various changes in form and detail can be made without departing from the spirit and scope of the present inventive concepts described and defined by the following \claims.

1. A system for a user to edit an arrangement comprising information regarding the relationship between two or more source data files, the system comprising:
a processing unit;
a first library comprising one or more source data files; and
a user interface comprising a display and a user input device;
wherein the processing unit provides a graphical user interface on the display; and
wherein the processing unit is configured such that the user can modify an initial arrangement of source data files via the graphical user interface to produce a modified arrangement of source data files.

2-54. (canceled)
